(19) United States
(12) Patent Application Publication
(10) Pub. No.: US 2022/0395785 A1
(43) Pub. Date: Dec. 15, 2022

(54) DEVICE FOR GENERATING AND DELIVERING LATHER

(71) Applicant: Moose Innovations Ltd., Tel-Aviv (IL)

(72) Inventors: Boaz ZUCKER, Tel Aviv (IL); Shlomo ZUCKER, Michmoret (IL)

(73) Assignee: Moose Innovations Ltd., Tel-Aviv (IL)

(21) Appl. No.: 17/632,552

(22) PCT Filed: Aug. 5, 2020
(86) PCT No.: PCT/IB2020/057387

§ 371 Date: Feb. 3, 2022

Related U.S. Application Data
(60) Provisional application No. 62/975,246, filed on Feb. 12, 2020.

(30) Foreign Application Priority Data
Aug. 5, 2019 (IL) PCT/IL2019/050889

(51) Int. Cl. B01F 21/10; B01F 23/235; B01F 27/808; B01F 27/81; B01F 27/96; B01F 33/501; B01F 33/453; B01F 35/32; B01F 35/90

(52) U.S. Cl. CPC B01F 21/10; B01F 23/2351; B01F 27/808; B01F 27/8111; B01F 27/96; B01F 33/50111; B01F 33/453; B01F 35/32025; B01F 35/90; B01F 2035/99

(57) ABSTRACT

An aspect of the invention discloses a system for making lather in a cup, comprising a cup comprising an impeller and a heater in said cup and a base for said cup having a power source configured to provide power to said impeller and to said heater.

### RELATED APPLICATION/S

This application claims the benefit of priority of U.S. Provisional Patent Application No. 62/975,246 filed on 12 Feb. 2020, which is a CIP of PCT application number IL2019/050889 filed on 5 Aug. 2019, which claims priority from U.S. Provisional Patent Application No. 62/714,707 filed on 5 Aug. 2018.

The contents of the above applications are all incorporated by reference as if fully set forth herein in their entirety.

### FIELD AND BACKGROUND

The present invention relates to a device for generating and dispensing a warm lather and in particular, to such a device and system for producing a warm lather such as shaving cream, from a capsule.

In order to soften and condition facial beards in preparation for shaving by a razor, it is the common practice to first apply a shaving cream or lather to the facial region. The use of lather is preferred by many shavers, for in lather the active ingredients are intermingled with air bubbles to provide greater penetrating action on the beard.

Shaving cream and/or lathers generally used today are provided from aerosol canisters that eject a gel, foam or lather that is applied to the face. Such canisters are provided in different cosmetic forms and fragrances, consistencies, so as to personalize the feel to an individual user. Furthermore, the canisters as sold as large sizes limiting the user's options for changing the type of shaving gel/cream to use, therein not allowing the user a daily option of what type of lather to use.

In past a shaver made his own lather by adding warm water to a shaving soap in a mug and agitating the mixture with his brush to develop a froth of soapsuds. The lather was then applied to the face by the brush, the brush being used to collect the lather from the mug. While this process is time consuming it did allow a user to determine the type of soap to use on a daily basis. And while this time consumption led to the development of a more convenient aerosol canisters in which lather under pressure is dispensed by pressing a release valve. It does present its limitations with respect to the temperature and type of lather to use. Furthermore, while aerosol canisters are convenient some argue that the lather they produce is in some respects inferior to the self-made type.

### SUMMARY

According to an aspect of some embodiments of the present invention there is provided a system for making lather in a cup, comprising: a cup comprising an impeller and a heater in said cup; a base for said cup having a power source configured to provide power to said impeller and to said heater.

According to some embodiments of the invention, said heater comprises an induction body in said cup and a heating element in said base.

According to some embodiments of the invention, said base comprises a liquid compartment configured to provide liquid for said making of said lather.

According to some embodiments of the invention, said liquid consists essentially of water.

According to some embodiments of the invention, said liquid includes less than 30% water by volume.

According to some embodiments of the invention, said impeller in said cup comprises a capsule element configured to receive at least one capsule comprising raw lather material for said making of said lather.

According to some embodiments of the invention, said cup further comprises a capsule compartment configured to receive at least one capsule and to keep said capsule within said cup.

According to some embodiments of the invention, said capsule compartment is further configured to guide said capsule to contact said impeller.

According to some embodiments of the invention, said base comprises at least According to some embodiments of the invention, said base comprises a contactless rotor configured to rotate said impeller in said cup.

According to some embodiments of the invention, said impeller comprises said heater.

According to some embodiments of the invention, said base further comprises a controller.

According to some embodiments of the invention, said controller comprises a timer that finishes a cycle of generating lather in 30 seconds or less.

According to some embodiments of the invention, said controller comprises a communications module configured to communicate with at least one external device.

According to some embodiments of the invention, said base comprises a battery configured to activate the device for from about 5 times to about 20 times without the need to recharge said battery or to change said battery.

According to some embodiments of the invention, said base is cordless.

According to some embodiments of the invention, said impeller detaches from said cup.

According to some embodiments of the invention, said liquid is inserted into said cup through said capsule compartment using a channel.

According to some embodiments of the invention, said heater is configures to heat the walls of said cup.

According to some embodiments of the invention, said cup, said heater and said impeller are waterproofed.

According to some embodiments of the invention, said base is waterproofed.

According to some embodiments of the invention, said heater modulates temperatures from about 4 degrees Celsius to about 80 degrees Celsius.

According to some embodiments of the invention, said heater modulates temperatures below 80 degrees Celsius.

According to some embodiments of the invention, the system further comprising at least one capsule comprising raw lather materials.

According to some embodiments of the invention, said at least one capsule comprises multiple compartments; and wherein each compartment of said multiple compartments contain a different material.

According to some embodiments of the invention, said different material is selected from the group consisting of at least one lather-generating raw material, aftershave, softener, perfume, medicaments, said at least one liquid, water and any combination thereof.

According to some embodiments of the invention, said at least one capsule comprises said liquid.

According to some embodiments of the invention, said at least one capsule comprises a shape selected from the group consisting of: a ring, a dome, a pill, a tablet, a geometrical shape, a non-geometrical shape and/or any combination thereof.

According to some embodiments of the invention, said capsule compartment is sized and shaped according to said capsule shape.

According to some embodiments of the invention, said base comprises multiple capsule compartments.

According to some embodiments of the invention, said capsule compartment comprises a cage-like compartment.

According to some embodiments of the invention, said capsule compartment is configured to hold said capsule and to allow said liquid to move through said capsule compartment.

According to an aspect of some embodiments of the present invention there is provided a method of generating lather in a system for making lather in a cup, comprising mixing and heating a fluid with at least one capsule in a cup until lather is form.

According to some embodiments of the invention, said heating comprises modifying a temperature of one or more of said cup, said impeller, said liquid; and any combination thereof.

According to some embodiments of the invention, said mixing comprises mixing in a center of said cup, in a periphery of said cup and/or a combination of both.

According to some embodiments of the invention, the method further comprising inserting said at least one capsule inside a capsule compartment.

According to some embodiments of the invention, the method further comprising receiving at least one liquid from at least one liquid source.

According to some embodiments of the invention, said mixing comprises rotating at least one impeller located in said cup.

According to some embodiments of the invention, said at least one capsule comprises at least one lather-generating raw material.

According to some embodiments of the invention, the method further comprising providing at least one other material with said at least one lather-generating raw material.

According to some embodiments of the invention, the method further comprising allowing said liquid to move through said capsule compartment to dissolve said capsule.

According to some embodiments of the invention, said capsule compartment is a cage-like capsule compartment.

According to an aspect of some embodiments of the present invention there is provided a lather generating mechanism, comprising: a cup configured to receive one or more capsules, said capsules comprising a plurality of lather generating raw materials; at least one rotor comprising an axis of rotation, which rotates to rotate an impeller located in said cup, said impeller rotates to generate said lather; wherein generation of lather is performed by mixing said plurality of raw materials by means of shear force between surfaces generated by said rotating of said impeller.

According to some embodiments of the invention, said surfaces are parallel to said axis of rotation.

According to some embodiments of the invention, said surfaces are perpendicular to said axis of rotation.

According to an aspect of some embodiments of the present invention there is provided a system for making lather in a cup, comprising: a cup comprising an impeller in said cup; a base for said cup configured to provide power to said impeller and to provide heat to said lather. Following is a non-exclusive list including some examples of embodiments of the invention. The invention also includes embodiments which include fewer than all the features in an example and embodiments using features from multiple examples, also if not expressly listed below.

Example 1. A system for making lather in a cup, comprising:

a. a cup comprising an impeller and a heater in said cup;

b. a base for said cup having a power source configured to provide power to said impeller and to said heater.

Example 2. The system according to example 1, wherein said heater comprises an induction body in said cup and a heating element in said base.

Example 3. The system according to example 1, wherein said base comprises a liquid compartment configured to provide liquid for said making of said lather.

Example 4. The system according to example 3, wherein said liquid consists essentially of water.

Example 5. The device according to example 3, wherein said liquid includes less than 30% water by volume.

Example 6. The system according to example 1, wherein said impeller in said cup comprises a capsule element configured to receive at least one capsule comprising raw lather material for said making of said lather.

Example 7. The system according to example 1, wherein said cup further comprises a capsule compartment configured to receive at least one capsule and to keep said capsule within said cup.

Example 8. The system according to example 7, wherein said capsule compartment is further configured to guide said capsule to contact said impeller.

Example 9. The system according to example 1, wherein said base comprises at least one rotor configured to rotate said impeller.

Example 10. The system according to example 1, wherein said base comprises a contactless rotor configured to rotate said impeller in said cup.

Example 11. The system according to example 1, wherein said impeller comprises said heater.

Example 12. The system according to example 1, wherein said base further comprises a controller.

Example 13. The system according to example 12, wherein said controller comprises a timer that finishes a cycle of generating lather in 30 seconds or less.

Example 14. The system according to example 12, wherein said controller comprises a communications module configured to communicate with at least one external device.

Example 15. The system according to example 1, wherein said base comprises a battery configured to activate the device for from about 5 times to about 20 times without the need to recharge said battery or to change said battery.

Example 16. The system according to example 1, wherein said base is cordless.

Example 17. The system according to example 1, wherein said impeller detaches from said cup.

Example 18. The system according to example 3, wherein said liquid is inserted into said cup through said capsule compartment using a channel.

Example 19. The system according to example 1, wherein said heater is configured to heat the walls of said cup.

Example 20. The system according to example 1, wherein said cup, said heater and said impeller are waterproofed.

Example 21. The system according to example 1, wherein said base is waterproofed.

Example 22. The system according to example 1, wherein said heater modulates temperatures from about 4 degrees Celsius to about 80 degrees Celsius.

Example 23. The system according to example 1, wherein said heater modulates temperatures below 80 degrees Celsius.

Example 24. The system according to example 1, further comprising at least one capsule comprising raw lather materials.

Example 25. The system according to example 24, wherein said at least one capsule comprises multiple compartments; and wherein each compartment of said multiple compartments contain a different material.

Example 26. The system according to example 25, wherein said different material is selected from the group consisting of at least one lather-generating raw material, aftershave, softener, perfume, medicaments, said at least one liquid, water and any combination thereof.

Example 27. The system according to example 24, wherein said at least one capsule comprises said liquid.

Example 28. The system according to example 24, wherein said at least one capsule comprises a shape selected from the group consisting of: a ring, a dome, a pill, a tablet, a geometrical shape, a non-geometrical shape and/or any combination thereof.

Example 29. The system according to example 7, wherein said capsule compartment is sized and shaped according to said capsule shape.

Example 30. The system according to example 1, wherein said base comprises multiple capsule compartments.

Example 31. The system according to example 7, wherein said capsule compartment comprises a cage-like compartment.

Example 32. The system according to example 7, wherein said capsule compartment to hold said capsule and to allow said liquid to move through said capsule compartment.

Example 33. The system according to example 1, wherein said heater heats said liquid.

Example 34. The system according to example 3, wherein said liquid is heated before said liquid contacts said capsule.

Example 35. The system according to example 1, wherein said impeller comprises an elliptical form.

Example 35. The system according to example 1, wherein said impeller comprises a round form.

Example 36. A method of generating lather in a system for making lather in a cup, comprising mixing and heating a fluid with at least one capsule in a cup until lather is form.

Example 37. The method according to example 36, wherein said heating comprises modifying a temperature of one or more of said cup, said impeller, said liquid; and any combination thereof.

Example 38. The method according to example 36, wherein said mixing comprises mixing in a center of said cup, in a periphery of said cup and/or a combination of both.

Example 39. The method according to example 36, further comprising inserting said at least one capsule inside a capsule compartment.

Example 40. The method according to example 36, further comprising receiving at least one liquid from at least one liquid source.

Example 41. The method according to example 36, wherein said mixing comprises rotating at least one impeller located in said cup.

Example 42. The method according to example 36, wherein said at least one capsule comprises at least one lather-generating raw material.

Example 43. The method according to example 36, further comprising providing at least one other material with said at least one lather-generating raw material.

Example 44. The method according to example 36, further comprising allowing said liquid to move through said capsule compartment to dissolve said capsule.

Example 45. The method according to example 36, wherein said capsule compartment is a cage-like capsule compartment.

Example 46. The method according to example 36, further comprising heating said liquid before contacting said capsule.

Example 47. A lather generating mechanism, comprising:

a. a cup configured to receive one or more capsules, said capsules comprising a plurality of lather generating raw materials;

b. at least one rotor comprising an axis of rotation, which rotates to rotate an impeller located in said cup, said impeller rotates to generate said lather;

wherein generation of lather is performed by mixing said plurality of raw materials by means of shear force between surfaces generated by said rotating of said impeller.

Example 48. The lather generating mechanism according to example 47, wherein said surfaces are parallel to said axis of rotation.

Example 49. The lather generating mechanism according to example 47, wherein said surfaces are perpendicular to said axis of rotation.

Example 50. A system for making lather in a cup, comprising:

a. a cup comprising an impeller in said cup;

b. a base for said cup configured to provide power to said impeller and to provide heat to said lather.

Example 51. A lather generating mechanism, comprising:

a. a cup;

b. an impeller that rotates to generate a flow of a liquid;

c. a compartment for receiving one or more lather generating tablets, said lather generating tablets comprising a plurality of lather generating raw materials, said compartment comprising openings that allow inflow of said liquid into said compartment but do not allow said lather generating tablets to exit said compartment;

wherein said flow of said liquid follows a path from said impeller to said compartment to allow said liquid to dissolve said one or more lather generating tablets and release said lather generating raw materials into said liquid;

wherein said flow creates turbulence which generates said lather.

Example 52. The lather generating mechanism according to example 51, wherein said cup comprises a bottom at the lowest part of said cup, an opening at the highest part of said cup and surrounding walls connecting between said bottom and said opening.

Example 53. The lather generating mechanism according to example 51, wherein said surrounding walls generate said pathway for said flow.

Example 54. The lather generating mechanism according to example 51, wherein said flow having a general circular direction.

Example 55. The lather generating mechanism according to example 51, wherein said flow having a general direction towards said opening of said cup.

Example 56. The lather generating mechanism according to example 51, wherein said impeller is located in said bottom of said cup.

Example 57. The lather generating mechanism according to example 51, wherein said openings in said compartment comprise an area of from about 0.1 cm² to about 1 cm².

Example 58. A method of generating lather, comprising:

a. inserting one or more lather generating tablets comprising a plurality of lather generating raw materials in a lather generating tablet compartment;

b. rotating an impeller located to create a flow of a liquid, said flow following a path from said impeller to said lather generating tablet compartment;

c. dissolving said one or more lather generating tablets by channeling said flow through said lather generating tablet compartment, thereby releasing said lather generating raw materials into said liquid;

d. mixing said lather generating raw materials in said liquid by further rotating said impeller.

Example 59. The method according to example 58, wherein said mixing said lather generating raw materials in said liquid is performed in a cup.

Example 60. The method according to example 58, wherein said lather generating tablet compartment is located in said cup.

Example 61. The method according to example 58, wherein said impeller is located in said cup.

Example 62. The method according to example 58, wherein said path further continues from said lather generating tablet compartment back to said impeller.

Example 63. The method according to example 58, wherein said flow further flows in a general direction of an opening at a highest part of said cup.

Example 64. The method according to example 58, wherein a combination of said flow flowing through said path and said flow flowing in a general direction of an opening at a highest part of said cup create a turbulence that further mixes said lather generating raw materials in said liquid, thereby generating said lather.

Example 65. The method according to example 58, further comprising heating said liquid before rotating said impeller.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks, might be expected to use completely different methods, e.g., making use of expert knowledge and/or the pattern recognition capabilities of the human brain, which would be vastly more efficient than manually going through the steps of the methods described herein.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1a is a schematic diagram of an exemplary lather generating and dispensing device, according to some embodiments of the invention;

FIG. 1b is a schematic diagram of an exemplary cup of the lather generating and dispensing device, according to some embodiments of the invention;

FIGS. 2a-b are illustrations of an exemplary device and an exploded view showing the internal components of the device, according to some embodiments of the invention;

FIGS. 2c-e are illustrations of an exemplary device, according to some embodiments of the invention;

FIGS. 3a-b is an illustration of an exemplary device having a detachable cup 104, according to some embodiments of the invention;

FIGS. 4a-d are illustrations of a first exemplary mixing mechanism, according to some embodiments of the invention;

FIGS. 5a-b are illustrations of a second exemplary mixing mechanism, according to some embodiments of the invention;

FIGS. 6a-c are illustrations of two embodiments of impellers, according to some embodiments of the invention;

FIGS. 6d-g are illustrations of a plurality of embodiments of impellers, according to some embodiments of the invention;

FIGS. 7a-e are illustrations of an exemplary magnetic coupling between the impeller and the rotor, according to some embodiments of the invention;

FIGS. 8a-f is an embodiment of an exemplary capsule compartment, according to some embodiments of the invention;

FIGS. 8g-i is an embodiment of an exemplary capsule compartment in an exemplary lather generating and dispensing device, according to some embodiments of the invention;

FIGS. 8j-l is an embodiment of an exemplary impeller, according to some embodiments of the invention;

FIGS. 8m-p is an embodiment of an exemplary elliptic impeller, according to some embodiments of the invention;

FIGS. 8q-s are schematic representations of flows created in a cup by an impeller, according to some embodiments of the invention;

FIGS. 9a-b is an embodiment of an exemplary heater, according to some embodiments of the invention;

FIGS. 10a-d are embodiments of exemplary capsules, according to some embodiments of the invention;

FIG. 11 is a flowchart of a method of use of the lather generating and dispensing device, according to some embodiments of the present invention;

FIGS. 12 and 13 is a flowchart of a method for producing lather in the lather generating and dispensing device where the device is connected to an/or comprises a water source, according to some embodiments of the present invention; and

FIG. 14 is a flowchart of a method for producing lather in the lather generating and dispensing device where the water source or any other liquid source is included in the capsule, according to some embodiments of the present invention;

### DESCRIPTION OF SPECIFIC EMBODIMENTS OF THE INVENTION

The present invention relates to a device for generating and dispensing a warm lather and in particular, to such a device and system for producing a warm lather such as shaving cream, from a capsule.

### Overview

An aspect of some embodiments of the invention relates to mechanically generating lather on demand from a lather capsule. In some embodiments of the invention, the lather temperature is thermally modified. Optionally or additionally, the lather is generated in a same location as the location where the capsule is inserted. In some embodiments, the location is a cup. Optionally or additionally, the lather temperature is kept by actively mixing the lather in the cup while heating the cup. In some embodiments, the lather is generated by shear forces. In some embodiments, the lather is generated by keeping a capsule in a confined location while flowing liquids through the confined location. In some embodiments, the confined location is a cage-like capsule compartment.

In some embodiments of the invention, the lather generating device is waterproof. In some embodiments of the invention, the lather generating device is wireless and receives power from an internal power source. In some embodiments, potential advantage of a waterproof device is that the device can be used in the shower or in proximity to wet environments.

An aspect of some embodiments of the invention relates to a cup comprising a heating element. In some embodiments, the heating element receives energy from a body while heating bodies heat the cup and the contents of the cup. In some embodiments, the reception of energy does not include physical contact between the source of energy and the heating bodies.

An aspect of some embodiments of the invention relates to a cup comprising a mixing element. In some embodiments, the mixing element can be detached from the cup. In some embodiments, the mixing element in the cup rotates by means of a rotor located in a body. In some embodiments, the rotating the mixing element does not include physical contact between the mixing element and the rotor.

An aspect of some embodiments of the invention relate to providing lather in a cup. In some embodiments, the cup is detachable from a device. In some embodiments, the cup comprises at least one lather mixing mechanism in the bottom. In some embodiments, said at least one lather mixing mechanism is in communication to a rotor located in the body of the device, therefore, when the rotor is activated in the body of the device, the at least one lather mixing mechanism is activated in the cup.

An aspect of some embodiments of the invention relate to providing a temperature modulated lather. In some embodiments, lather is provided at a temperature chosen by the user. In some embodiments, temperature modulation is performed on the lather raw materials while it is being generated. In some embodiments, temperature modulation is performed on the location where the lather is being generated. In some embodiments, temperature is kept by modulation of the temperature of the receptacle where the generated lather is kept. In some embodiments, temperature is kept by continuously mixing the lather. In some embodiments, temperature modulation comprises temperatures from about 4 degrees Celsius to about 80 degrees Celsius.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Exemplary General Device

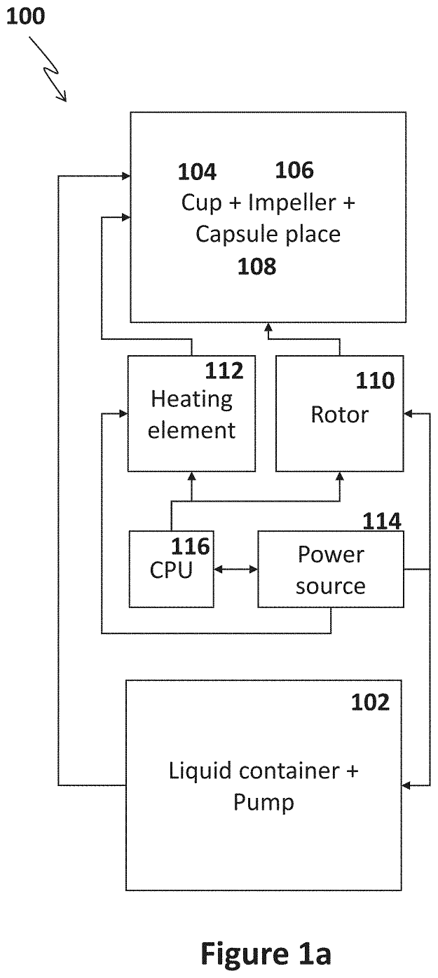

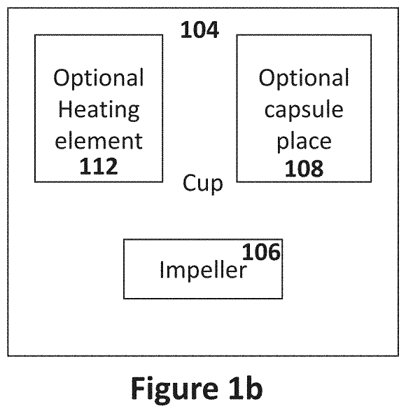

Referring now to the drawings, FIG. 1a illustrates a schematic diagram of an exemplary lather generating and dispensing device, according to some embodiments of the invention. In some embodiments, the device comprises a liquid container 102 configured to deliver liquid into a cup 104 by means of a pump. In some embodiments, the device does not comprise a built-in liquid container and instead the device receives the liquid from an external source, for example, by connecting the device to a sink, and/or by manually adding water into the cup, and/or by using a capsule which comprises the necessary liquid in the capsule itself.

In some embodiments, the cup has a form defined as a frustum of a right circular cone, also known as a “cup-shaped”. In some embodiments, the cup may have other shapes, like a cube, or a cone, or other geometrical shape. In some embodiments, the cup 104 is made of plastic or other polymer, ceramic, metal or any combination thereof. In some embodiments, the cup 104 can contain from about 100 ml of lather to about 500 ml of lather. Optionally from about 50 ml of lather to about 1000 ml of lather. Optionally from about 25 ml of lather to about 2000 ml of lather. For example, 50 ml, 100 ml, 150 ml, 200 ml, 300 ml, 400 ml, 500 ml, 750 ml, 1000 ml, 1500 ml or 2000 ml. Preferably from about 200 ml to about 300 ml, which the inventors have found is the average of lather used.

In some embodiments, the cup 104 comprises a detachable built-in mixing element 106. In some embodiments, the mixing element 106 is configured to mix the liquid and the lather raw materials thereby generating the lather. In the following description, the mixing element 106 will be called and impeller 106, but it should be understood that other mixing elements can be equally used to generate the lather.

In some embodiments, the cup 104 further comprises a capsule place 108. In some embodiments, the capsule place 108 is not a physical element, is just the place where the capsule is positioned before the activation of the device. In some embodiments, the capsule place 108 may comprise a capsule holding element (see below) or an actual capsule compartment (see 802).

In some embodiments, the device comprises a rotor 110 in direct communication (meaning mechanically attached) with the impeller 106. In some embodiments, the rotor 110 is not in direct communication (meaning not mechanically attached) with the impeller 106 but it causes the impeller 106 to rotate by other means, for example magnets (see below).

In some embodiments, the device comprises a heating element 112 configured to provide heat to the system to heat the lather, and optionally specifically provide heat to the cup 104 that will then heat the lather. In some embodiments, the system optionally heats the water to a desired temperature prior to mixing process. In some embodiments, a potential advantage of heating the water prior to the mixing of the lather raw materials with the water is that during the mixing process, the heat of the water creates uniformed hot air bubbles, which provide a thicker lather, while potentially avoiding heating bubbles of air while mixing, which may produce unwanted bubbles having different sizes. In some embodiments, the heating element resides in the body of the device. In some embodiments, the heating element resides in the cup 104 itself. In some embodiments, the heating element comprises parts located in the body of the device and parts located in the cup 104.

In some embodiments, the device comprises a power source 114 configured to supply the necessary energy to the different components of the device. In some embodiments, the device comprises a controller (CPU) 116 configured to control the operation of the different parts of the device.

Referring now to FIG. 1b, illustrating a schematic diagram of an exemplary cup of the lather generating and dispensing device, according to some embodiments of the invention. In some embodiments, the cup 104 comprises a detachable impeller 106, and optionally also includes a capsule place 108 and also optionally includes a heating element 112.

### Exemplary Device

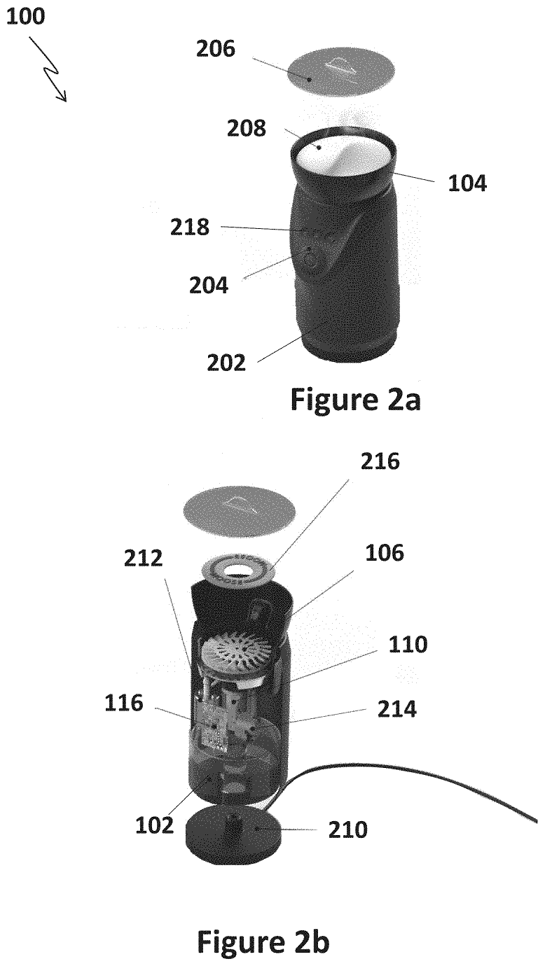

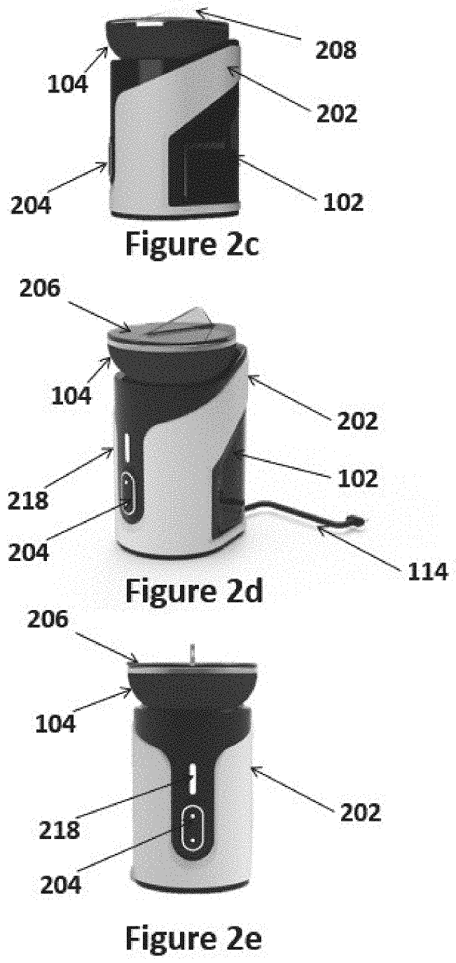

Referring now to FIGS. 2a-b, showing an illustration of an exemplary lather generating and dispensing device and an exploded view showing the internal components of the device, according to some embodiments of the invention. Same numbers were kept from same parts as shown in FIG. 1. FIG. 2a shows an exemplary device comprising a body 202, a control interface 204 configured to allow the user to active/deactivate the device, a cup 104, a user interface 218 configured to provide information to the user about the activation of the device and an optional cap 206 for the cup 104. FIG. 2a also shows the hot lather 208 as a matter of example. In some embodiments, the user interface 218 comprises one or more lights, optionally of different colors, which inform the user about statuses of the device, for example: ready to be activated, lather generation in process, lather generation complete, errors, etc. In some embodiments, the user interface 218 is a digital screen configured to provide visual information to the user. FIG. 2b shows exemplary internal components of the device comprising a powered docket station 210, a water container 102, a rotor 110, a detachable built-in impeller 106 inside the cup 104, a water pump 212, a controller 116, an optional flow sensor 214 configured to monitor and sense the flow of liquids from the water container 102 to the cup 104 and an exemplary capsule 216 (not part of the internal components of the device) configured as a rounded tablet with an orifice at its center.

Referring now to FIGS. 2c-e, showing illustrations of another exemplary lather generating and dispensing device, according to some embodiments of the invention. FIGS. 2c-e show an exemplary lather generating and dispensing device in three different views, the lather generating and dispensing device comprising a cup 104, optionally a removable cup, a body 202 and a water container 102, optionally a removable water container. In some embodiments, the body 202 comprises a control interface 204 and a user interface 218. In some embodiments, the device comprises an optional cap 206 for the cup 104. FIG. 2d also shows the optional cable for the power source 114.

### Exemplary Embodiments of Power Sources

In some embodiments, the power source 114 that provides the required energy to the device is an external power source (e.g. a plug connected to the electricity) using for example a powered docket station 210. In some embodiments, the power source 114 that provides the required energy to the device is an internal power source (e.g. batteries, rechargeable batteries). In some embodiments, the device is configured to accept energy from either/or both internal and external the power sources 114 (e.g. a plug connected to the electricity and internal batteries and rechargeable batteries). In some embodiments, where the device is a portable device, other methods of providing an energy source are used, for example, solar energy, manual activation of the device, etc.

### Exemplary Embodiments of Water/Liquid Compartment

In some embodiments, the water/liquid compartment 102 that provides the required water/liquid to the device to create the lather is a built in compartment comprising a dedicated tube configured to deliver the liquid into the cup 104. In some embodiments, the device can receive the liquids from an external water/liquid source (e.g. a tube connected on one side to the device and on the other to an external water plumbing). In some embodiments, the device is configured to accept water/liquid from either/or both internal 102 and external the water/liquid sources (e.g. a tube connected on one side to the device and on the other to an external water plumbing and a dedicated container inside the device configured to be filled with water/liquid manually by the user).

In some embodiments, as mentioned above, the device comprises dedicated pumps 212 configured to mobilize the water/liquid from one point (either from outside water/liquid sources or dedicated internal water/liquid container) into the cup 104.

In some embodiments, the liquid compartment 102 is a removable water compartment.

In some embodiments, the pump is configured to be operational at a pressure of about 1-2 bar. In some embodiments, the pump is configured to be operated at a pressure of up to about 15 bar.

In some embodiments, liquids are inserted into the cup 104 from the top of the cup 104. In some embodiments, a potential advantage of this configuration is to allow the cup 104 to have a completely sealed bottom, which avoids leaking of liquids from the cup 104 into the rotor 110.

In some embodiments, the controller 116 is connected to the pump and it controls the actions of the pump. In some embodiments, the controller comprises instructions to activate the pump for a specific period of time, for example for 1 second, 1.5 seconds, 2 seconds, optionally from about 0.5 seconds to about 3 seconds, optionally form about 1 second to about 5 seconds, optionally from about 0.1 seconds to about 10 seconds. In some embodiments, a unit of time (for example 1 second) equals a specific volume of liquid (for example 10 ml). In some embodiments, the ratio time:volume is from about 1 sec:10 ml to about 1 sec:100 ml, optionally from about 1 sec:5 ml to about 1 sec:500 ml.

In some embodiments, the pump is a two way pump configured to add liquid and/or to remove liquid.

In some embodiments, the system optionally heats the water to a desired temperature prior to mixing process. In some embodiments, a potential advantage of heating the water prior to the mixing of the lather raw materials with the water is that during the mixing process, the heat of the water creates uniformed hot air bubbles, which provide a thicker lather, while potentially avoiding heating bubbles of air while mixing, which may produce unwanted bubbles having different sizes.

### Exemplary Detachable Cup

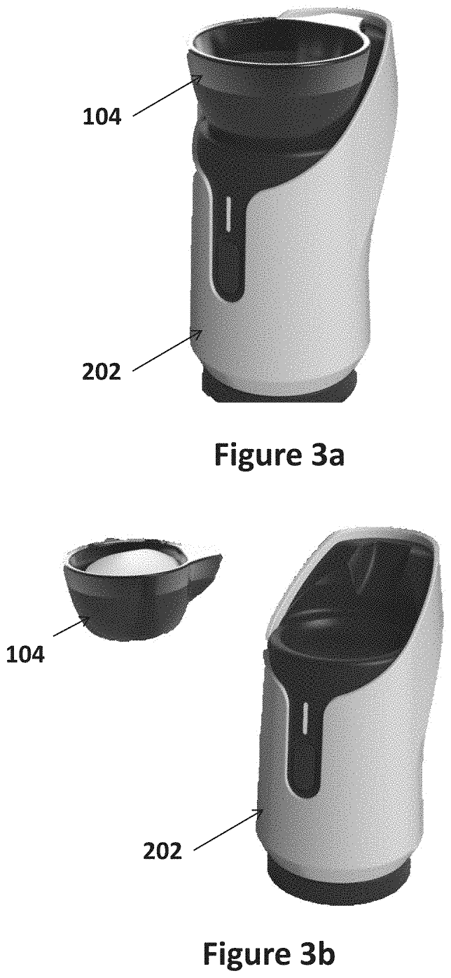

Referring now to FIGS. 3a-b, showing an exemplary device having a detachable cup 104, according to some embodiments of the invention. In some embodiments, the cup 104 is configured to be detached from the body 202 of the device. In some embodiments, a potential advantage of having a detachable cup is to allow the user to use the warm lather at another location from where the lather was made, for example, to use in the shower.

In some embodiments, the device comprises a sensor configured to sense if the cup 104 is connected to the body 202. In some embodiments, when the cup 104 is not detected on the body 202, the device will not activate any of the mechanisms, for example, the rotor 110, or the heater 112.

### Exemplary Embodiments of Lather Mixing/Generating Mechanism

In some embodiments, the device comprises mechanical means to ensure appropriate mixing and later generation. For example, the mixing is driven by a rotor 110 and/or a motor and/or a piezoelectric element in direct communication (meaning mechanical coupling) to an impeller 106, a propeller, an agitator, a mixing plate, a mixing rod, the like or any combination thereof, located inside the cup 104. In some embodiments, the rotor 110 is in communication with the CPU 116 (controller) to receive instructions related to the rate and timing of operation to optimize generation of lather. In some embodiments, the CPU is configured to monitor the forces exerted by the rotor and/or the resistance from the impellers, which is directly proportional to the rate of generation of the lather (see below for further explanation on the method of generating lather).

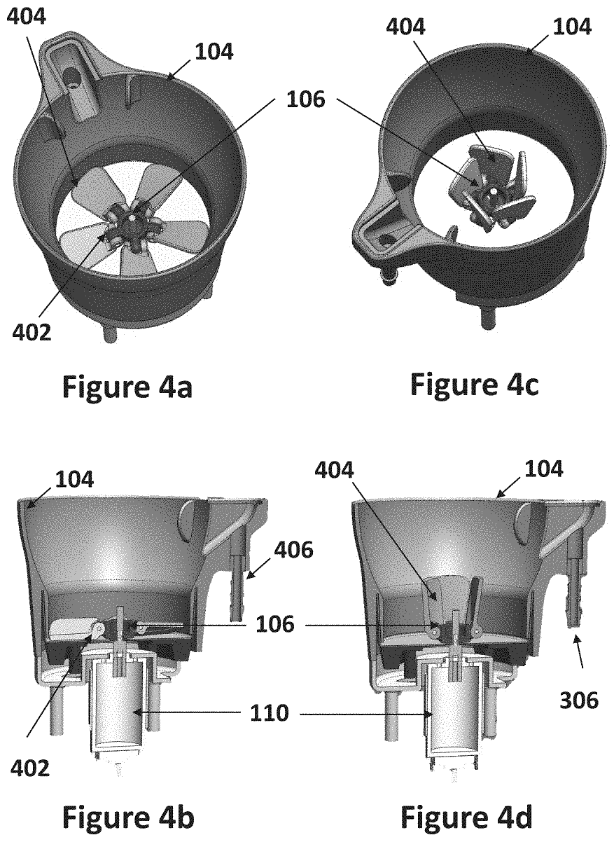

Referring now to FIGS. 4a-d showing a first exemplary mixing mechanism, according to some embodiments of the invention. In some embodiments, the impeller 106 comprises one or more pivots 402, which allow the wings 404 of the impeller 106 to raise. FIGS. 4a and 4b show the impeller 106 in a down configuration. In some embodiments, the wings 404 are down when the device is not active. In some embodiments, the rotation of the impeller 106 and the friction with the lather materials will cause the wings 404 of the impeller 106 to raise, as shown for example in FIGS. 4c and 4d. In some embodiments, a potential advantage of having raising wings 404 is to allow the wings to mix the lather better. In some embodiments, in the process of making the lather, the water and the lather raw material are mixed by the impeller 106. In some embodiments, the system optionally heats the water to a desired temperature prior to mixing process. In some embodiments, a potential advantage of heating the water prior to the mixing of the lather raw materials with the water is that during the mixing process, the heat of the water creates uniformed hot air bubbles, which provide a thicker lather, while potentially avoiding heating bubbles of air while mixing, which may produce unwanted bubbles having different sizes. It is natural that some parts of the mix will become denser before others during the mixing process. In some embodiments, in order to ensure a homogenous mixing of lather, the impeller 106 is provided with pivoted wings, which are configured to raise during the mixing of the lather and can reach higher places in the cup during the mixing. In some embodiments, another potential advantage of having raising wings 404 is to allow the wings to mix the heat through the lather better and ensure the homogenous heating of the lather, as the lather is being mixed, hot lather get mixed with less hot lather until the whole cup 104 is filled with homogenously mixed and heated lather.

It can also be seen in FIGS. 4b and 4d the connection between the impeller 106 and the rotor 110. In FIGS. 4a-d it is also shown the channel 306 from which the water/liquid is brought into the cup 104.

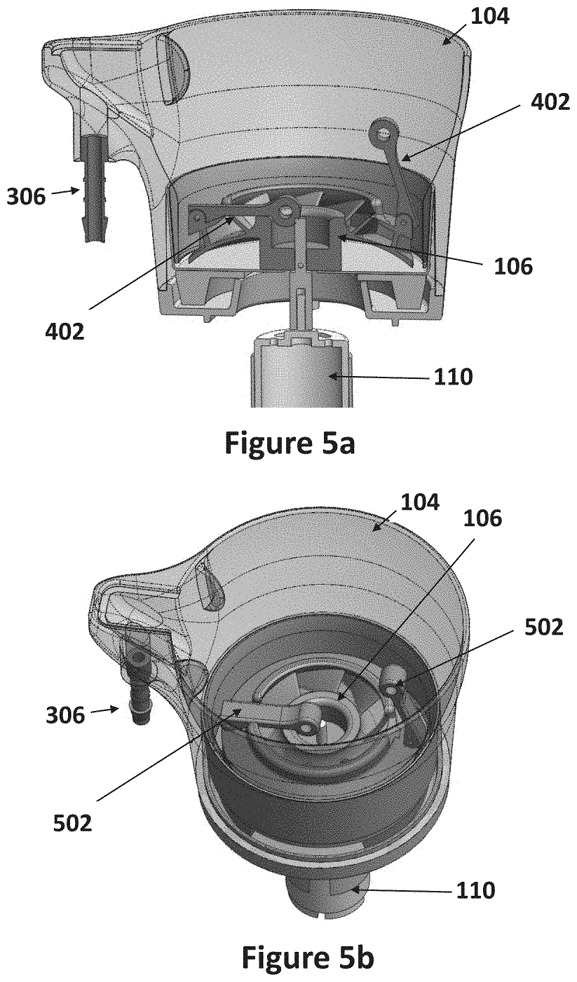

Referring now to FIGS. 5a-b showing a second exemplary mixing mechanism, according to some embodiments of the invention. In some embodiments, the impeller 106 comprises at least one (in the figure shown two) arm 502 which are configured to raise with the rotation of the impeller 106. In some embodiments, a potential advantage of having raising arms 502 is to allow them to mix the lather better. In some embodiments, in the process of making the lather, as stated above, the water and the lather raw material are mixed by the impeller 106. It is natural that some parts of the mix will become denser before others during the mixing process. In some embodiments, in order to ensure a homogenous mixing of lather, the impeller 106 is provided with arms 502, which are configured to raise during the mixing of the lather and can reach higher places in the cup 104 during the mixing. In some embodiments, another potential advantage of having raising arms 502 is to allow the wings to mix the heat thought the lather and ensure the homogenous heating of the lather, as the lather is being mixed, hot lather get mixed with less hot lather until the whole cup 104 is filled with homogenously mixed and heated lather.

It can also be seen in FIGS. 5a-b the connection between the impeller 106 and the rotor 110. In the Figure it is also shown the channel 306 from which the water/liquid is brought into the cup 104.

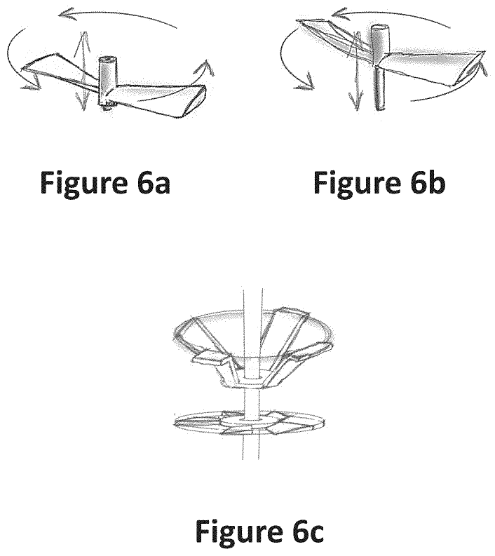

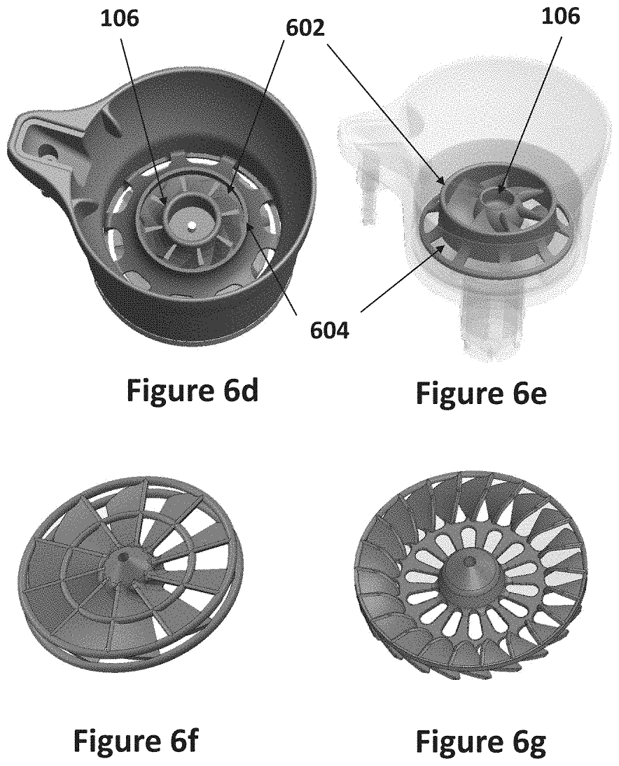

Referring now to FIGS. 6a-c showing two embodiments of impellers, according to some embodiments of the invention. Sometimes, once the lather is formed, hard and dense, there is a possibility that the impeller will freely rotate without mixing the lather. In some embodiments, one solution to this matter is to provide an impeller that is configured to move up and down on an axle, as shown for example in FIGS. 6a and 6b, where in FIG. 6a the impeller is down and in FIG. 6b the impeller is up. In some embodiments, a similar solution to this problem is shown in FIG. 6c, showing an impeller that is configured to move up and down on an axle and furthermore, the wings are configured to also move upwards while rotating.

Referring now to FIGS. 6d-g showing a plurality of embodiments of impellers, according to some embodiments of the invention. In some embodiments, in addition to the impeller 106 there is provided a stator 602 configured to stay stationary during the production of the lather, as sown for example in FIGS. 6d and 6e. In some embodiments, the stator 602 works like a mixer between the moving part (the impeller) and the static part (itself) increasing the turbulence inside the cup 104 and thereby increasing the mixing of the lather during the production. In some embodiments, during the mixing, the lather is sucked from the center of the stator into the moving propeller, and then the lather is ejected from the orifices 604 located on the sides of the stator. In some embodiments, the impeller itself comprises architectures which increase the turbulence inside the cup, as shown for example in FIGS. 6f and 6g.

### Exemplary Coupling Between Body and Impeller in a Detachable Cup Configuration

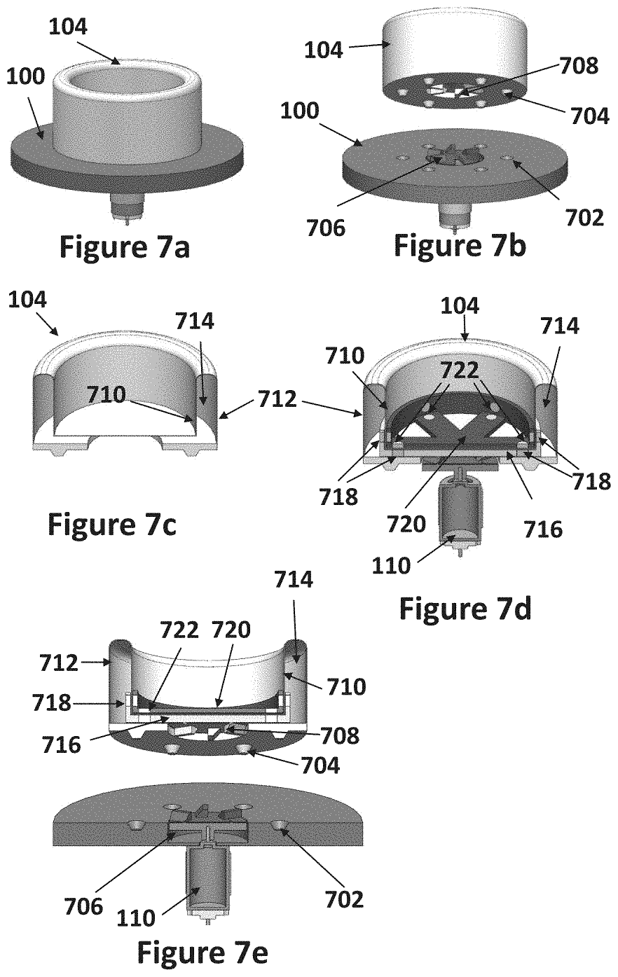

In some embodiments, where the cup 104 is a detachable cup, a dedicated coupling between the cup 104 comprising the impeller 106 and the rotor 110 is used. In some embodiments, it would be a potential advantage to provide a cup 104 that does not allow the liquids to leave the cup, for example, from the bottom of the cup where the coupling between the impeller and rotor is located. Therefore, in some embodiments, the coupling between the rotor 110 and the impeller 106 is actuated by means of a series of magnets, optionally located on both sides. Referring now to FIGS. 7a-b showing exemplary illustrations of a magnetic coupling between the impeller and the rotor, according to some embodiments of the invention. FIGS. 7a and 7b illustrate an embodiment where the cup 104 is a detachable cup. FIG. 7a shows the cup 104 connected to the top of the device 100. The device 100 is shown partially to ease the explanations. FIG. 7b shows the cup 104 detached from the top of the device 100. In some embodiments, the interface between the cup 104 and the device 100 comprises a plurality of female 702—male 704 connectors configured to ease the cup 104 into the correct location. In some embodiments, the interface can be magnetic to avoid from the cup 104 to involuntarily detach from the device 100. In some embodiments, other coupling mechanism can be used for the interface between the cup 104 and the device 100, for example rubber/plastic gear couplers, rotational locking. FIG. 7b also shows the coupling 706 of the rotor 110 located at the device 100, and the coupling 708 of the impeller 106 located on the bottom of the cup 104.

In some embodiments, the cup 104 comprises a double wall (internal wall 710 and external wall 712) including a space 714 between the walls 710/712, as shown for example in FIG. 7c. Referring now to FIG. 7d, showing that, in some embodiments, in the space 714 between the walls 710/712 there is a plate 716 comprising a plurality of magnets 718. In some embodiments, the plate 716 covers the bottom of the cup 104 and comprises perpendicular walls extending from the bottom. In some embodiments, magnets are located at the bottom part of the plate and/or on the perpendicular walls extending from the bottom. In some embodiments, at the bottom of the plate 716 there is the coupling 708 shown in FIG. 7b. In some embodiments, when the coupling 706 of the rotor 110 rotates it causes the coupling 708 to rotate as well and therefore it causes the plate 716 to rotate as well. In some embodiments, on the inside of the cup 104 between the internal walls 710 of the cup 104 there is an impeller 720 comprising a plurality of magnets 722. In some embodiments, when the magnets 718 located on the plate 716 and the magnets 722 located on the impeller 720 are aligned, the rotation of the plate 716 will cause the rotation of the impeller 720. In some embodiments, a potential advantage of this configuration is to provide a cup 104 that comprises a sealed bottom, which avoids from liquids to spill in the coupling between the rotor 110 and the impeller 106/720. FIG. 7e shows a detached configuration of the cup 104 from the device 100, showing the internal magnetic coupling as shown in FIGS. 7a-d.

### Exemplary Embodiments of Capsule Compartment

In some embodiments, the capsule 216 is laid down on top of the impeller 106. In some embodiments, once the impeller 106 is activated together with the entry of water, for example from the channel 406, the movement of the impeller 106 dissolves the capsule 216 and the production of lather begins. In some embodiments, a capsule holding element is added at the center of the impeller configured to hold the capsule while the impeller rotates and, due to the addition of water, it dissolves while generating the lather. In some embodiments, the capsule holding element is a protrusion configured to match the hole of a ring-shape capsule. In some embodiments, the ring-shape capsule is positioned in the protrusion and it stays in place by means of friction forces between the protrusion and the capsule. In some embodiments, the capsule holding element is a cage-like element configured to trap the capsule. In some embodiments, the cage-like element is on top of the impeller. In some embodiments, the cage-like element is not on top of the impeller. In some embodiments, the cage-like element is in proximity to the channel 406 from where the liquid configured to dissolve the capsule exits.

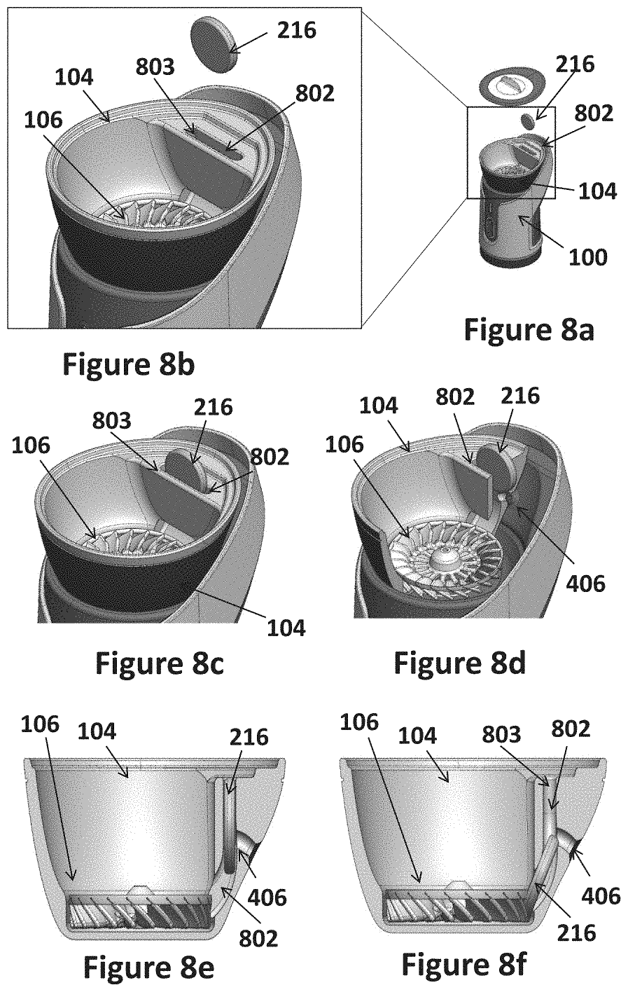

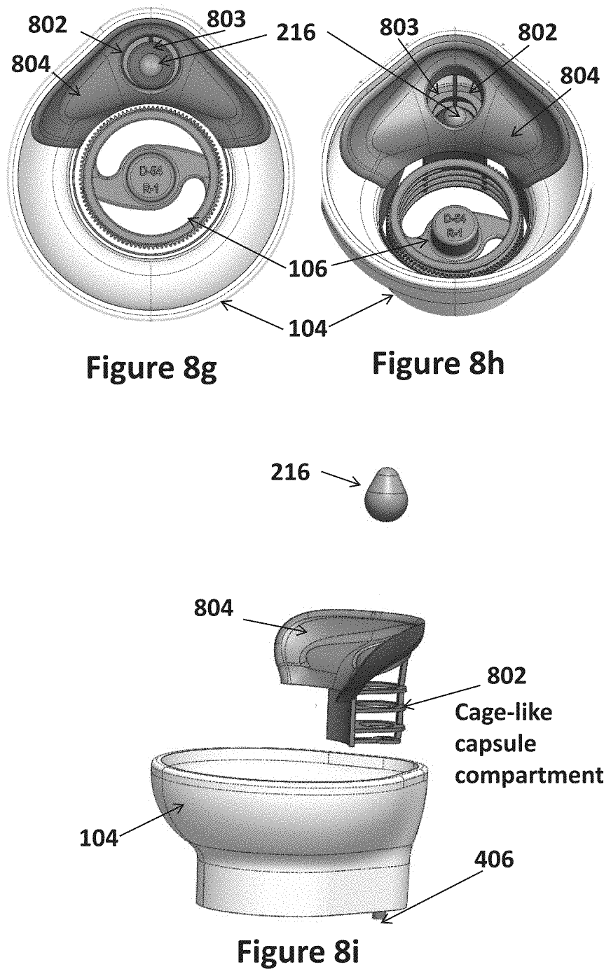

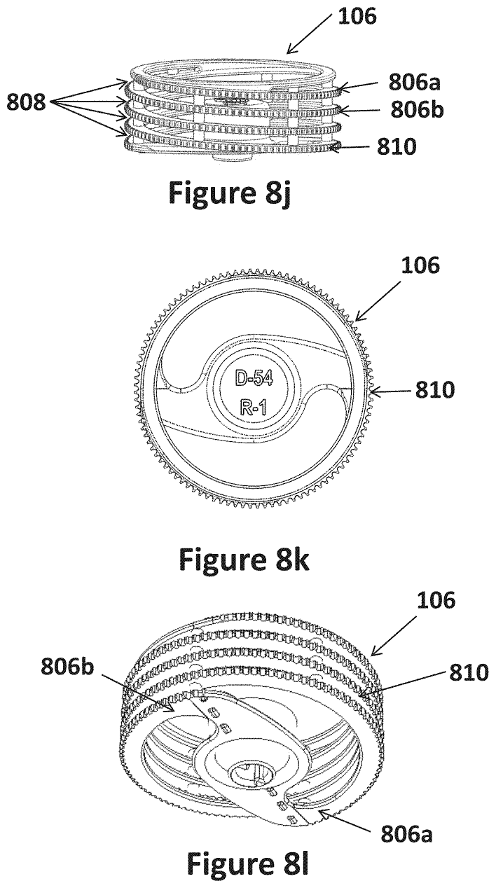

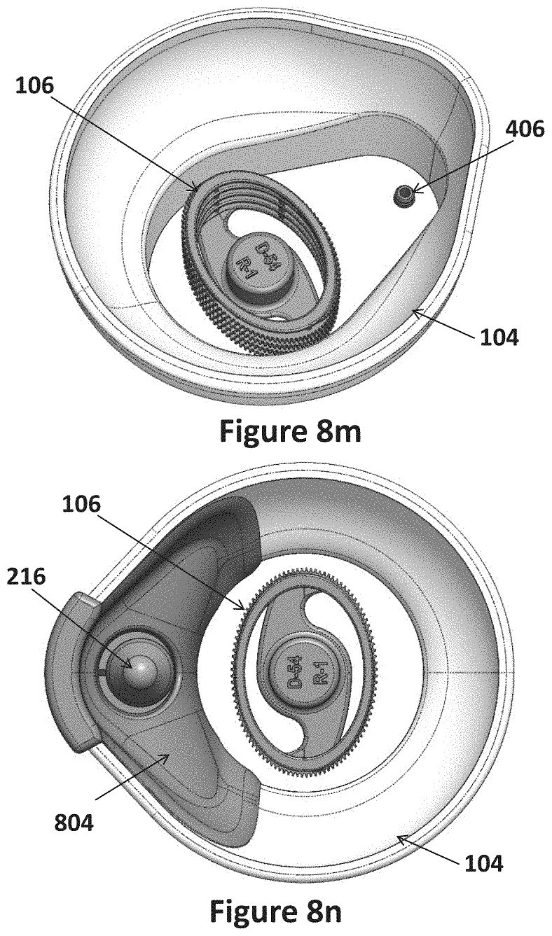

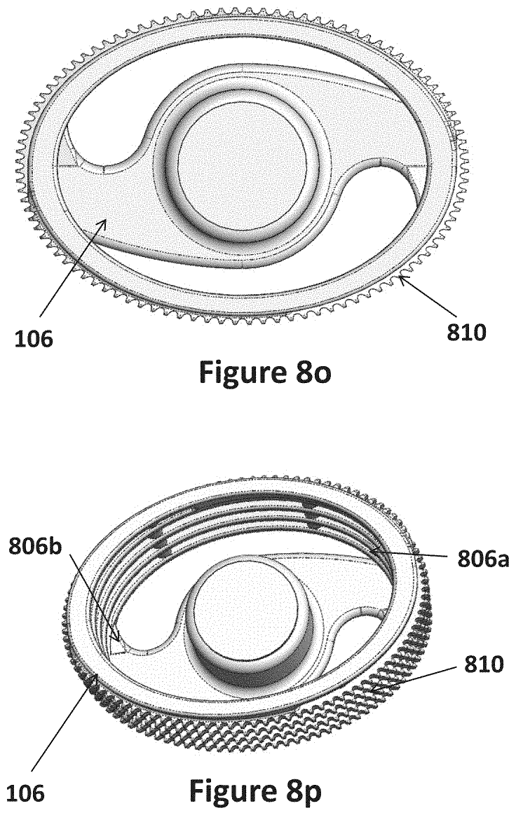

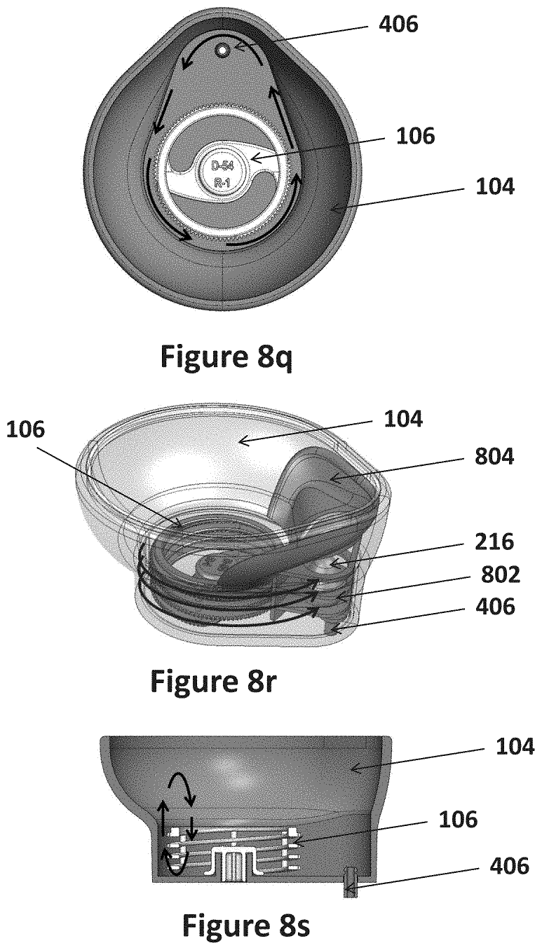

Referring now to FIGS. 8a-f, showing an exemplary embodiment of a capsule compartment, according to some embodiments of the invention. In some embodiments, instead of laying down the capsule 216 on top of the impeller, the device 100 comprises a capsule compartment 802. In some embodiments, the capsule compartment 802 comprises a slot 803 (or orifice) configured to receive the capsule 216. In some embodiments, the capsule compartment 802 is incorporated in the body of the device 100. In some embodiments, the capsule compartment 802 is incorporated in the cup 104, as shown for example is FIGS. 8a-f. FIG. 8a, shows a generic view of the device 100, having a capsule compartment 802 integrated in the cup 104, the cup having also incorporated the impeller 106 and the optional cap 206. FIG. 8b is a zoom-in of FIG. 8a, showing in more detail the cup 104 with the capsule compartment 802 and the impeller 106. FIG. 8c shows an example of how a capsule 216 is inserted in the slot 803 of the capsule compartment 802. FIG. 8d shows a cross view of the cup 104 with the capsule compartment 802. In some embodiments, the channel 406 is in communication with the capsule compartment 802 as shown, for example, in FIGS. 8d-8f. FIG. 8e shows an example of how the capsule 216 slides inside the capsule compartment 802 through the slot 803, until reaches the bottom of the capsule compartment 802, which is in direct communication with the impeller 106, as shown for example in FIG. 8f. As can be seen in FIG. 8f, the water will flow from the channel 406, through the capsule 216, until it reaches the bottom of the cup 104. Once the impeller 106 begins to rotate, the force of the impeller 106 on the capsule 216 will cause the capsule 216 to be crushed, and in the presence of water, the capsule 216 will dissolve, and the lather generation will commence.

Referring now to FIGS. 8g-8i, showing another exemplary embodiment of the device, according to some embodiments of the invention. In some embodiments, the capsule compartment 802 is configured as a cage-like capsule compartment, as shown for example in FIG. 8i. In some embodiments, the cage-like compartment holds the capsule 216 in place while allows the flow of liquids through the cage-like compartment and the capsule. In some embodiments, this allows the liquids to dissolve the capsule while keeping the capsule inside the cage-like compartment. In some embodiments, the capsule compartment 802 is included in a removable element 804 configured to hold the capsule compartment 802, to provide a complementary form to the cup 104 to the space where the lather that its being generated will accumulate and to separate the generated lather from the zone where the capsule compartment 802 and the channel 406 (not shown) are located. FIG. 8i shows an example of the removable element 804 separated from the removable cup 104. In some embodiments, cage-like compartment is intended as a compartment comprising openings that allow the entry of liquids while block the exit of the capsule. In some embodiments, the openings comprise an area of from about 0.1 cm² to about 1 cm². In some embodiments, the openings comprise a circular form, optionally a square form, optionally a rectangular form. In some embodiments, the number of openings is from about 1 to about 50.

FIGS. 8g and 8h are upper view and upper perspective view, respectively, of an exemplary device comprising a removable cup 104, an impeller 106 inside the removable cup 104 and a removable element 804 comprising a cage-like capsule compartment 802 comprising an orifice 203 to insert a capsule 216), according to some embodiments of the invention. Also shown is an exemplary capsule 216 having a drop form (better shown for example in FIG. 8i), according to some embodiments of the invention.

FIG. 8i is an exploded view of the device, according to some embodiments of the invention, comprising the removable cup 104, the removable element 804 comprising a cage-like capsule compartment 802 and also shown an exemplary capsule 216 having a drop form.

FIGS. 8j, 8k and 8l are side view, upper view and bottom perspective view, respectively, of an exemplary impeller 106, according to some embodiments of the invention. In some embodiments, the impeller 106 is configured as a double continuous thread 806a-b, optionally as a single continuous thread, optionally a triple or more continuous thread. In some embodiments, the space 808 between threads is used to increase the turbulence of the liquid inside the cup 104. In some embodiments, the sides of the impeller 106 may optionally comprise teeth 810 configured to crush any undissolved parts of the capsule 216.

Referring now to FIGS. 8m-p, showing a schematic representation of a device comprising an elliptic impeller and a related elliptic impeller, according to some embodiments of the invention. In some embodiments, the impeller comprises an elliptic form, as shown for example in FIGS. 8m-q. In some embodiments, a potential advantage of using an elliptic impeller is the creation of higher levels of turbulence in the cup due to the difference in the distance created between the impeller and the walls of the cup during the rotation of the impeller, the turbulence that helps in the generation of the lather. In some embodiments, the characteristics of the elliptic impellers are similar to those described for the impellers disclosed in FIGS. 8j-l. In some embodiments, the impeller may comprise a rectangular form, a triangular form, a star-like form or a square form.

FIGS. 8q, 8r and 8s are upper view, perspective view and side view, respectively, showing schematically the direction of the flow created by the impeller, according to some embodiments of the invention. In some embodiments, as shown in FIG. 8q, the counterclockwise rotation of the impeller 106 causes a counterclockwise movement of the liquid (liquid not shown) in a radial direction inside the cup 104. In some embodiments, as shown in FIG. 8r, when the removable element 804 comprising a cage-like capsule compartment 802 is inside the cup 104, the counterclockwise rotation of the impeller 106 causes the counterclockwise movement of the liquid (liquid not shown) in a radial direction inside the cup 104 and through the openings of the cage-like capsule compartment 802. In some embodiments, this movement of the liquid through the cage-like capsule compartment 802 helps the capsule 216 trapped inside the cage-like capsule compartment 802 to dissolve. In some embodiments, as shown for example in FIG. 8s, the rotation of the impeller 106 further causes the liquid to move in the axial direction. In some embodiments, the combination of the movement in the radial direction with the movement in the axial direction helps to mix the lather raw material with the liquid and to create the lather.

### Exemplary Embodiments of Heating Elements

In some embodiments, the heater is an electrical temperature modulator configured to provide the heat necessary in the creation of lather. For example, the heater may be configured to have a power profile from about 3 Watts and up to about 300 Watts, more preferably the heater utilizes a power profile of about 100 Watts.

In some embodiments, the heater heats the cup 104 which then heats the lather while is being created inside the cup 104. In some embodiments, the device comprise multiple heaters configured to heat, either independently or all at once, the cup 104.

A potential advantage of heating the cup 104 is in cases where, for example, the exterior environment where the device is located is cold and the user would like to keep the lather warm.

In some embodiments, the heater is configured to decrease, increase or maintain the temperature of the cup 104. In some embodiments, the user can chose the temperature of the lather. In some embodiments, according to the choice of the user, the device will either decrease, increase or maintain the temperature of the cup and/or the lather.

As mentioned above, in some embodiments, the user choses the temperature of the lather final product. In some embodiments, the temperature of the lather is between 4 degrees Celsius and 40 degrees Celsius. Optionally, between 8 degrees Celsius and 30 degrees Celsius. Optionally, between 14 degrees Celsius and 20 degrees Celsius. For example 5 degrees Celsius, 18 degrees Celsius, 35 degrees Celsius. Optionally at room temperature.

In some embodiments, the heating element utilizes induction heating to heat either the cup 104 and/or other parts of the system, for example, the impeller or the liquid. In some embodiments, where induction heating is used, an electrically conducting object (or body) is inserted in the cup (optionally inside the walls of the cup) and they are heated by electromagnetic induction, as will be explained below.

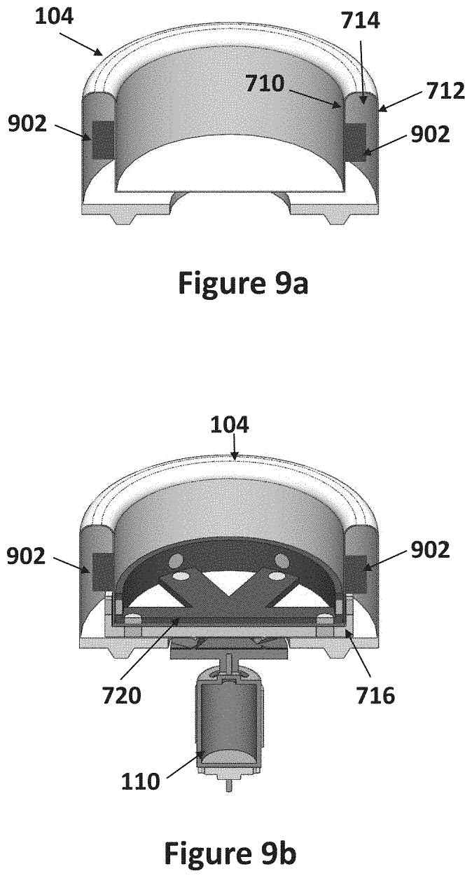

Referring now to FIGS. 9a-b, illustrating an embodiment of a heater, according to some embodiments of the invention. In some embodiments, the conducting bodies 902 are located in the space 714 between the walls 710/712 of the cup 104. In some embodiments, the conducting bodies 902 are located above the plate 716, as shown for example in FIG. 9b. In some embodiments, the electromagnetic induction to heat the conducting bodies comes from the device 100. In some embodiments, the electromagnetic induction to heat the conducting bodies comes from the same magnets that rotate the impeller 106. In some embodiments, the conducting bodies go around the internal space 714 like a ring, “hugging” the internal wall 710 from the inside. In some embodiments, this configuration allows to only heat the internal walls of cup, while leaving the external walls 712 of the cup 104 unheated, which allows the user to hold the cup 104 without getting burned.

In some embodiments, in a device as shown for example in FIGS. 4b, 4d, 5a and 5b, where there is a physical element extending from the body of the device into the inside of the cup, a heating element wiring configured to activate the heating element in the cup will run from the body of the device and will make contact with the heating element. In some embodiments, in a device as shown for example in FIGS. 3a, 3b, 7a-e, 8a-f and 9a-b, where there is no physical element extending from the body of the device into the inside of the cup, the heating element is as disclosed above, where the conducting bodies are being heated by electromagnetic induction.

### Exemplary Embodiments of Capsules

Capsules 216 or the like cartridge and/or inserts may be provided in optional forms and may contain at least one or more agents and/or precursors for forming a lather such as shaving cream. In some embodiments, the capsule 216 comprises a housing for containing at least one or more lather producing agents and/or precursors. In some embodiments, agents may be provided in optional forms, consistencies, and states for example including but not limited to fluid, liquid, gel, gas, solid, freeze dried, plasma, the like or any combination thereof. For example, the agents may in fluid form, loosely packed particles, compressed granulated particles, or a mixture thereof.

In some embodiments, the capsule 216 housing is provided in optional forms for example including a rigid housing, a loose form packaging, and flexible housing. In some embodiments, the capsule housing is provided from any materials conducive and capable of for both storing agents and to facilitate forming lather when agents are exposed and/or introduced to water/liquid. For example, capsule housing may be formed from any material or a combination of materials for example including but not limited to metals, metallic alloys, polymers, plastics, hard plastics, flexible materials, the like or any combination thereof.

In some embodiments, the capsule 216 may comprise more than one compartments, for example, the housing has at least two sub-compartments. In such a multi compartment housing, each compartment may contain a different lathering agent.

In some embodiments, at least one face of the capsule may form a filter through which the prepared lather is delivered.

In some embodiments, at least one face of the housing may form a filter through which the prepared later is delivered.

In some embodiment a filter (not shown) may be disposed as part of capsule housing to facilitate lather production.

In some embodiments, capsules comprise an external material adapted to be dissolved by either a liquid and/or heat and/or physical puncture of the external material. In some embodiments, once the external material is dissolved or punctured, the contents of the capsule are released.

In some embodiments, the capsules 216 comprise at least one electronic identification device in the form of, for example, QR, RFID, picture recognition, etc. In some embodiments, each type of capsule comprise its own identification marker that is recognized by the device, as disclosed herein.

In some embodiments, the capsules are used only once. In some embodiments, capsules can be used a plurality of times.

In some embodiments, more than one capsule is used. In some embodiments, one capsule comprises generic lather raw materials and another capsule comprises additives to the lather. For example, the second capsule may comprise specialized gels, perfumes, medicine, minerals and more.

In some embodiments, the capsules are configured to completely dissolve in water. In some embodiments, the capsules are inserted into the cup 104 and on top of the impeller 106 and during the rotation of the impeller 106 the capsule is crushed by the impeller and dissolved by the water coming from the top of the cup 104.

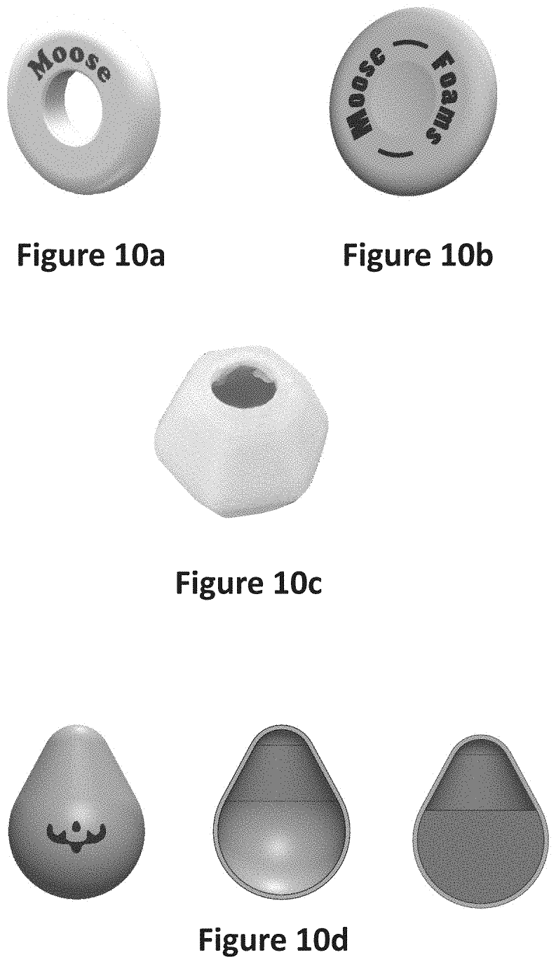

In some embodiments, the capsules 216 comprise a round configuration having a hole in the center, as shown in FIG. 10a. In some embodiments, the capsules 216 comprise a disk-like configuration, as shown in FIG. 10b. In some embodiments, the capsules 216 comprise a ball-like configuration, as shown in FIG. 10c, optionally comprising liquids inside the ball-like capsule. In some embodiments, the capsules 216 comprise a drop-like configuration, as shown for example in FIG. 10d. In some embodiments, as mentioned above, the drop-like capsule may contain one or more compartments, optionally having different materials inside each compartment. In some embodiments, the outer shell of the capsule is made of a material that dissolves when in contact with a liquid.

### Exemplary Embodiments of Circuitry/CPU/Controller

Device and modules therein are rendered operational with circuitry and electronics modules comprising a plurality of optional sub-modules for example including but not limited to a power supply sub-module, controller and/or processor sub-module, human interface sub-module, and memory sub-module. In some embodiments, electronics module may further comprise a communication module sub-module.

In some embodiments, processor sub-module provides the necessary processing hardware and/or software necessary to render the device functional.

In some embodiments, power sub-module provides the necessary hardware and/or software to power the device therein rendering the device operational.

In some embodiments, human interface sub-module provides the necessary processing hardware and/or software necessary to provide the device with the ability to interface with the user in at least one or more facets. In some embodiments, a human interface sub-module may for example include but is not limited to at least one or more of display, buttons, input keyboard, and light emitting diode displays the like or any combination thereof.

In some embodiments, a memory sub-module provides the necessary memory capabilities both in the form of hardware and/or software necessary to render the device functional.

In some embodiments, a communication sub-module provides the necessary processing hardware and/or software necessary to allow the device to communicate with at least one or more communication and processing device, for example, in the form of a computer, server, smartphone, mobile telephone, or the like communication and processing device. In some embodiments, the communication sub-module may utilize any communication protocol as is known in the art for example including but not limited to wireless communication, wireless fidelity (WIFI), near field communication (NFC), RF communication, optical communication, IR communication, BLUETOOTH, the like or any combination thereof.

In some embodiments, a communication submodule of electronics module may be in wireless communication with at least one or more communication and processing device to manage and/or monitor shaving use of at least one or more of lather, blades and/or razors. In some embodiments, such use monitoring may be utilized to automate purchase and/or ordering of new lather capsules and/or razor blades (not shown) or the like shaving accessories or personal care items, for example, including but not limited to balms, creams, gels, after-shave, cologne, perfumes, facial towels the like or any combination thereof.

In some embodiments, the device and/or systems are fit with a user safety and/or counterfeit measures to ensure that the device and/or system is used only with authorized and/or authentic capsules. In some embodiments, such a safety measures ensure that a user is not exposed to harmful agents and/or ingredients that may be utilized by a counterfeit lather capsule and/or lathering agent. In some embodiments, such safety measures are rendered with at least one or both of electronics module or capsule housing.

For example, electronics module and/or capsule housing may be utilized to facilitate electronic identification and/or verification of the authenticity and/or manufacturing integrity of capsule. In some embodiments, the capsule is provided with electronic identification, for example, including but not limited to a readable RFID tag and/or barcode or the like identification means that may be read and/or authenticated with at least one of electronics module and/or capsule housing.

### Exemplary Complementary Hardware

In some embodiments, the device comprises dedicated hardware configured to interconnect the device to a plurality of services provided over the internet. In some embodiments, the device comprises a plurality of sensors that monitor the performance of the device and, in some embodiments, the information is sent to dedicated servers where dedicated feedback messages are sent to the user. In some embodiments, the information collected is time that the device has been used, the type of capsule that is used, the sensed temperatures, the chosen temperatures by the user, user identification and more. For example, the user is notified when is time to change the disposable impellers. Another example, the user is notified when it is time to buy new capsules.

### Exemplary Methods

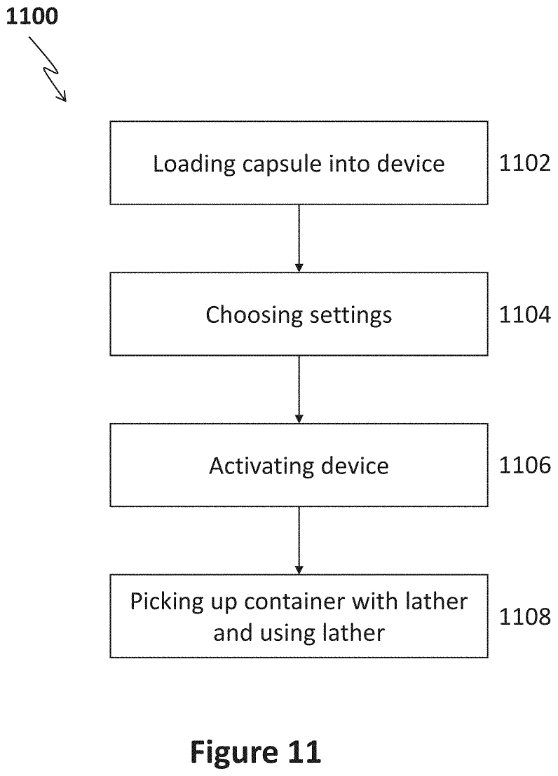

Referring now to FIG. 11 showing a flowchart of a method 1100 of use of the lather generating and dispensing device, according to some embodiments of the present invention. In some embodiments, the user begins by loading a capsule into the device 1102. In some embodiments, the user then continues by choosing the operational settings of the machine 1104. For example, in some embodiments, the user can choose the temperature of the lather, how much lather is produced, concentration of lather according to quantity of water that is used during the generation of the lather, a time of activation of the device if the user wants the lather to be ready at a certain time (in the morning for example). In some embodiments, the user then continues by activating the device 1106, and after a few minutes, picking up the container with the lather and using the lather 1108. In some embodiments, when the device is set to automatically generate the lather, the user does not need to activate the device, since the device will activate itself at the required time.

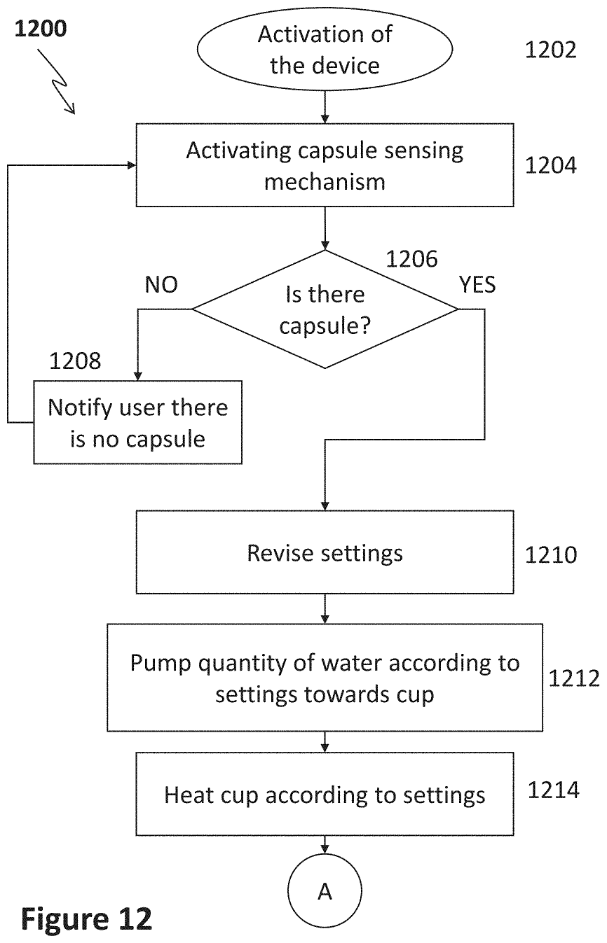

Referring now to FIG. 12 showing a flow chart of a method 1200 for producing lather in the lather generating and dispensing device where the device is connected to an/or comprises a water source, according to some embodiments of the present invention.

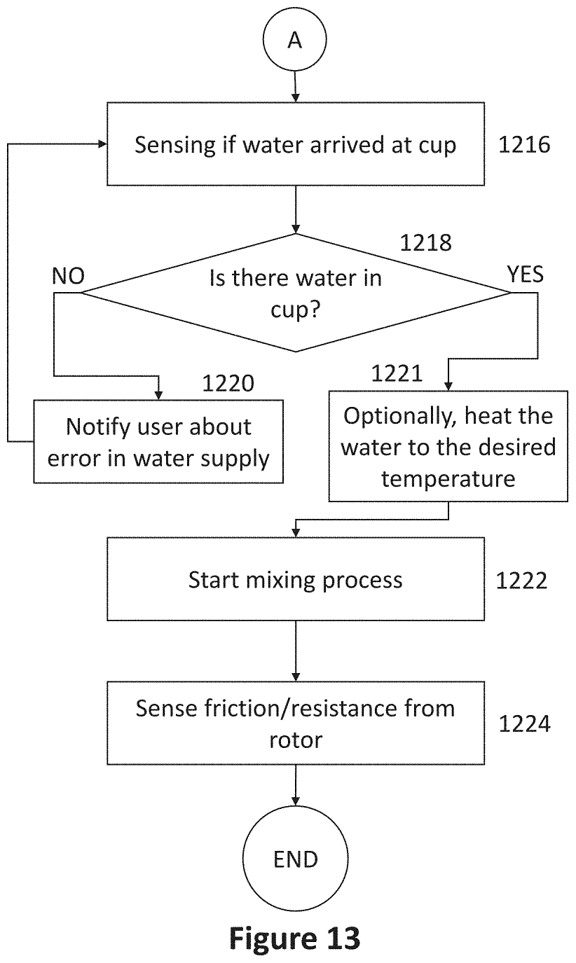

In some embodiments, the method begins with the activation of the device 1202 by the user, as explained above. In some embodiments, after the activation, the device activates the capsule sensing mechanism 1204, which evaluates if a capsule was loaded and/or received into device within the cup 1206. In some embodiments, if the machine senses that there is no capsule in the cup, the device notifies the user that there is no capsule 1208. In some embodiments, notifications to the user are displayed on a screen, or with light emissions on the device, or any other known mechanism known in the art. In some embodiments, the device continues to sense if there is capsule until a positive outcome of the sensing is achieved. In some embodiments, when the device confirms that there is a capsule in the cup, the device revises the chosen settings of the user 1210. In some embodiments, the device then pumps the necessary quantity of water or any other liquid according to the settings from the water source or any other liquid source towards the cup 1212. In some embodiments, the cup begins to be heated according to the settings 1214. (Flowchart continues following letter “A” in FIG. 13). In some embodiments, the device then activates the sensors 1216 that check if water/liquid is arriving to the cup 1218. In some embodiments, if the machine senses that water/liquid is not arriving to the cup, the device notifies the user that there is a problem with the water/liquid 1220 and stops the heating of the cup. In some embodiments, when the device confirms that there is water/liquid arriving to the cup, the system optionally heats the water to a desired temperature 1221. In some embodiments, a potential advantage of heating the water prior to the mixing of the lather raw materials with the water is that during the mixing process, the heat of the water creates uniformed hot air bubbles, which provide a thicker lather, while potentially avoiding heating bubbles of air while mixing, which may produce unwanted bubbles having different sizes. In some embodiments, the device then commences the mixing process 1222 while reactivating the heating of the cup. In some embodiments, the device monitors the friction and/or resistance of the impeller to assess if the lather mixing processing has finished 1224, thereby providing the user with a ready to use warm lather.

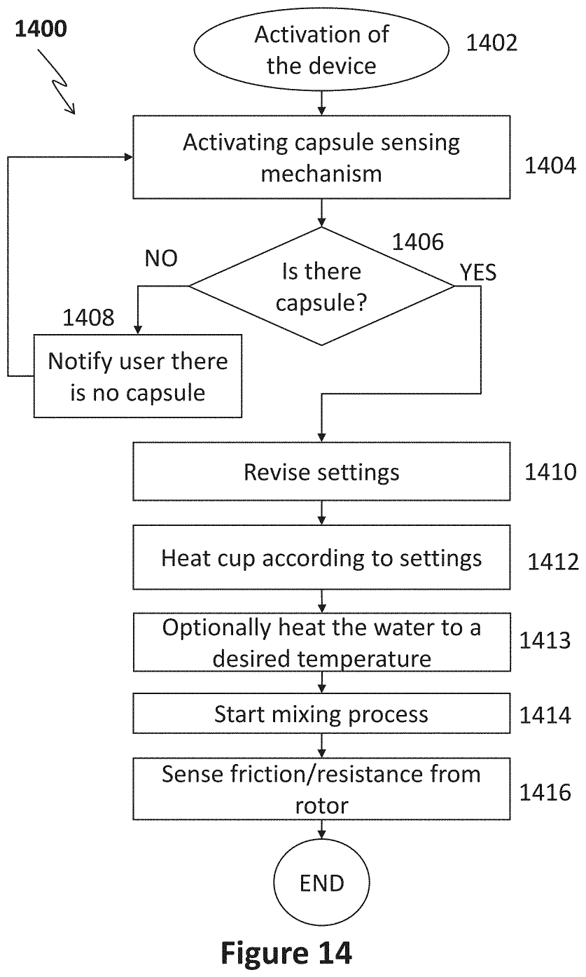

Referring now to FIG. 14 showing a flowchart of a method 1400 for producing lather in the lather generating and dispensing device where the water source or any other liquid source is included in the capsule, according to some embodiments of the present invention.

In some embodiments, the method begins with the activation of the device 1402 by the user, as explained above. In some embodiments, after the activation, the device activates the capsule sensing mechanism 1404, which evaluates if a capsule was loaded and/or received into device within cup 1406. In some embodiments, if the machine senses that there is no capsule in the cup, the device notifies the user that there is no capsule 1408. In some embodiments, notifications to the user are displayed on a screen, or with light emissions on the device, or any other known mechanism known in the art. In some embodiments, the device continues to sense if there is capsule until a positive outcome of the sensing is achieved. In some embodiments, when the device confirms that there is a capsule in the cup, the device revises the chosen settings of the user 1410. In some embodiments, the device then begins warming the cup according to the settings 1412. In some embodiments, the device optionally heats the water to a desired temperature 1413. In some embodiments, a potential advantage of heating the water prior to the mixing of the lather raw materials with the water is that during the mixing process, the heat of the water creates uniformed hot air bubbles, which provide a thicker lather, while potentially avoiding heating bubbles of air while mixing, which may produce unwanted bubbles having different sizes. In some embodiments, the device then begins the mixing process 1414. In some embodiments, the device monitors the friction and/or resistance of the impeller to assess if the lather mixing processing has finished 1416, thereby providing the user with a ready to use warm lather.

### Exemplary Additional Uses of the System

In some embodiments, the system as disclosed above can be used for other than to generate lather. For example, in some embodiments, the cup is configured to contain a larger quantity of liquid and the capsule is configured to contain drinkable raw materials. For example, the capsule can contain protein shake raw materials which are inserted in the device. Then liquids are passed through the capsule as disclosed above, dissolving the protein shake raw materials into the liquids. Then the impeller mixes the protein shake raw materials and the liquids generating a protein shake. In some embodiments, other material can be included in the capsule, for example, fruit concentrate extracts, vegetable concentrate extracts, flavor concentrates, additives, etc. It is expected that during the life of a patent maturing from this application many relevant lather mixing devices will be developed; the scope of the terms used herein are intended to include all such new technologies a priori.

As used herein with reference to quantity or value, the term “about” means “within ±20% of”.

The terms “comprises”, “comprising”, “includes”, “including”, “has”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular forms “a”, “an” and “the” include plural references unless the context clearly dictates otherwise. For example, the term “a compound” or “at least one compound” may include a plurality of compounds, including mixtures thereof.

Throughout this application, embodiments of this invention may be presented with reference to a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Unless otherwise indicated, numbers used herein and any number ranges based thereon are approximations within the accuracy of reasonable measurement and rounding errors as understood by persons skilled in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A system for making lather in a cup, comprising:
a. a cup comprising an impeller;
b. a base comprising a heater for said cup, said base having a power source configured to provide power to said impeller and to said heater;
wherein said cup further comprises a capsule compartment configured to receive at least one capsule and to keep said capsule within said cup.

2. The system according to claim 1, wherein said heater comprises an induction body in said base and a heating element in said cup.

3. The system according to claim 1, wherein said base comprises a liquid compartment configured to provide liquid for said making of said lather.

4.-6. (canceled)

7. The system according to claim 1, wherein said base comprises at least one rotor configured to rotate said impeller.

8. The system according to claim 1, wherein said base comprises a contactless rotor configured to rotate said impeller in said cup.

9. The system according to claim 1, wherein said base further comprises a controller; and wherein said controller comprises a timer that finishes a cycle of generating lather in 30 seconds or less.

10.-11. (canceled)

12. The system according to claim 1, wherein said base comprises a battery configured to activate the device for from about 5 times to about 20 times without the need to recharge said battery or to change said battery.

13.-14. (canceled)

15. The system according to claim 1, wherein said heater is configured to heat the walls of said cup.

16. The system according to claim 1, wherein said cup, said heater, said base and said impeller are waterproofed.

17. (canceled)

18. The system according to claim 1, wherein said heater modulates temperatures from about 4 degrees Celsius to about 80 degrees Celsius.

19. (canceled)

20. The system according to claim 1, further comprising at least one capsule comprising raw lather materials.

21.-25. (canceled)

26. The system according to claim 1, wherein said capsule compartment comprises a cage-like compartment.

27. The system according to claim 3, wherein said capsule compartment holds said capsule and allows said liquid to move through said capsule compartment.

28. The system according to claim 3, wherein said heater heats said liquid.

29. (canceled)

30. The system according to claim 1, wherein said impeller comprises a form selected from the group consisting of: an elliptical form and a round form.

31. (canceled)

32. A method of generating lather in a system for making lather in a cup, comprising:
a. inserting at least one capsule comprising at least one lather-generating raw material inside a capsule compartment;
b. mixing a fluid with said at least one capsule in a cup, while heating said cup, until lather is form.

33. The method according to claim 32, wherein said heating comprises modifying a temperature of one or more of said cup, an impeller, said liquid; and any combination thereof.

34. The method according to claim 32, wherein said mixing comprises mixing in a center of said cup, in a periphery of said cup and/or a combination of both.

35.-36. (canceled)

37. The method according to claim 32, wherein said mixing comprises rotating at least one impeller located in said cup.

38.-39. (canceled)

40. The method according to claim 32, further comprising allowing said liquid to move through said capsule compartment to dissolve said capsule.

41.-54. (canceled)
